(19) United States
(12) Patent Application Publication
(10) Pub. No.: US 2020/0380037 A1
(43) Pub. Date: Dec. 3, 2020

(54) Information Retrieval Precision Evaluation Method, System and Device and Computer-Readable Storage Medium

(71) Applicant: PING AN TECHNOLOGY (SHENZHEN) CO., LTD., Shanzhen (CN)

(72) Inventors: Qingyuan ZHAO, Shenzhen (CN); Yong WEI, Shenzhen (CN); Zishen LV, Shenzhen (CN); Liang XU, Shenzhen (CN); JING XIAO, Shenzhen (CN)

(73) Assignee: PING AN TECHNOLOGY (SHENZHEN) CO., LTD., Shenzhen (CN)

(21) Appl. No.: 16/088,829

(22) PCT Filed: Jun. 30, 2017
(86) PCT No.: PCT/CN2017/091355

§ 371 Date: Sep. 27, 2018

(30) Foreign Application Priority Data
May 10, 2017 (CN) 201710327380.3

(51) Int. Cl. G06F 16/9038; G06F 16/903; G06F 11/34

(52) U.S. Cl. CPC G06F 16/9038; G06F 11/3409; G06F 16/90344

(57) ABSTRACT

An information retrieval precision evaluation method and device and a computer-readable storage medium. The method includes: retrieving, by virtue of a first predetermined retrieval system, at least one first retrieval result corresponding to a predetermined keyword, and retrieving, by virtue of a second predetermined retrieval system, at least one second retrieval result corresponding to the keyword; generating a first retrieval sequence number corresponding to the first retrieval result and a second retrieval sequence number corresponding to the second retrieval result according to a preset sequence number generation rule; and analyzing the generated first retrieval sequence number and second retrieval sequence number according to a predetermined precision analysis rule to obtain precision of the first retrieval system and the second retrieval system.

### CROSS-REFERENCE TO RELATED APPLICATIONS

This application is the national phase entry of International Application No. PCT/CN2017/091355, filed on Jun. 30, 2017, which is based upon and claims priority to Chinese Patent Application No. CN2017103273803, filed on May 10, 2017, the entire contents of which are incorporated herein by reference.

### TECHNICAL FIELD

The present invention relates to the field of information retrieval, and particularly relates to an information retrieval precision evaluation method, system and device and a computer-readable storage medium.

### BACKGROUND

At present, the following four information retrieval result precision detection methods are relatively universal and popular:

1: Precision: a proportion of related results in retrieval results which are fed back is checked;

2: Mean Reciprocal Rank (MRR): functions of ranks in the returned results are distinguished, and a related feedback rank is higher, the corresponding result is better;

3: Mean Average Precision (MAP) calculation: an arithmetic mean of a retrieval precision rate mean (i.e., average precision) of each related document is calculated; and

4: Discounted Cumulative Gain (DCG): results obtained by a certain retrieval word are scored.

In the four methods commonly used at present, the first method is simplest and most universal, but has some defects such as slightly large calculated amount, dependence on manual marking for correlations of all retrieval results, and low precision caused by lack of consideration for ranks of the results.

The second method is relatively simple. However, only a first related result in retrieval is considered in the method, while during a practical engineering application, a user may be required to view multiple results for comprehensive evaluation rather than only pays attention to the first related result. Therefore, the method may not well meet a using requirement of the user in practical use, and leads to relatively low precision.

The ranks of the related results and all the correlations are comprehensively considered in the third method. However, in the method, the ranks of all the results in a repository are required to be considered, and large-scale manual screening is required. As a result, manpower and material resources are wasted, the efficiency is low and the error rate is high.

For the fourth method, excessive artificial factors are required in a scoring link, and it is difficult to implement quantization. Above all, the information retrieval result precision judgment methods commonly used at present have the problems of large calculated amount, requirement on large-scale manual screening, relatively low precision and the like.

### SUMMARY

The present invention is directed to provide an information retrieval precision evaluation method and device and a computer-readable storage medium, so as to solve the foregoing problems of a present information retrieval precision evaluation method.

To this end, a first aspect of the present invention provides an information retrieval precision evaluation method, which includes the steps of:

A: retrieving, by virtue of a first predetermined retrieval system, at least one first retrieval result corresponding to a predetermined keyword, and retrieving, by virtue of a second predetermined retrieval system, at least one second retrieval result corresponding to the keyword;

B: generating a first retrieval sequence number corresponding to the first retrieval result and a second retrieval sequence number corresponding to the second retrieval result according to a preset sequence number generation rule; and

C: analyzing the generated first retrieval sequence number and second retrieval sequence number according to a predetermined precision analysis rule to obtain precision of the first retrieval system relative to the second retrieval system.

A second aspect of the present invention provides an information retrieval precision evaluation system, which includes:

a retrieval module configured to retrieve, by virtue of a first predetermined retrieval system, at least one first retrieval result corresponding to a predetermined keyword and retrieve, by virtue of a second predetermined retrieval system, at least one second retrieval result corresponding to the keyword;

a sequence number generation module configured to generate a first retrieval sequence number corresponding to the first retrieval result and a second retrieval sequence number corresponding to the second retrieval result according to a preset sequence number generation rule; and

a precision judgment module configured to analyze the generated first retrieval sequence number and second retrieval sequence number according to a predetermined precision analysis rule to obtain precision of the first retrieval system relative to the second retrieval system.

A third aspect of the present invention provides an information retrieval precision evaluation device, which includes: a memory, a processor and an information retrieval precision evaluation system stored on the memory and capable of running on the processor, wherein the information retrieval precision evaluation system is executed by the processor to execute the steps of:

A: retrieving, by virtue of a first predetermined retrieval system, at least one first retrieval result corresponding to a predetermined keyword, and retrieving, by virtue of a second predetermined retrieval system, at least one second retrieval result corresponding to the keyword;

B: generating a first retrieval sequence number corresponding to the first retrieval result and a second retrieval sequence number corresponding to the second retrieval result according to a preset sequence number generation rule; and

C: analyzing the generated first retrieval sequence number and second retrieval sequence number according to a predetermined precision analysis rule to obtain precision of the first retrieval system relative to the second retrieval system.

A fourth aspect of the present invention provides a computer-readable storage medium storing therein at least one computer-readable instruction executable for processing equipment to implement the following operation:

A: retrieving, by virtue of a first predetermined retrieval system, at least one first retrieval result corresponding to a predetermined keyword, and retrieving, by virtue of a second predetermined retrieval system, at least one second retrieval result corresponding to the keyword;

B: generating a first retrieval sequence number corresponding to the first retrieval result and a second retrieval sequence number corresponding to the second retrieval result according to a preset sequence number generation rule; and

C: analyzing the generated first retrieval sequence number and second retrieval sequence number according to a predetermined precision analysis rule to obtain precision of the first retrieval system relative to the second retrieval system.

Compared with the prior art, the information retrieval precision evaluation method and device and computer-readable storage medium of the present invention have the following advantages: at first, the retrieval results corresponding to the predetermined keyword are retrieved through the determined retrieval systems, and the retrieval sequence numbers corresponding to the retrieval results are generated according to the preset sequence number generation rule; and then the retrieval sequence numbers are analyzed through the predetermined precision analysis rule to obtain the precision of the retrieval systems. Implementing the information retrieval precision evaluation method and device and computer-readable storage medium of the present invention effectively avoids manual marking for all retrieval results, reduces the calculated amount, also considers ranks of the retrieval results related to the preset keyword in the retrieval results and effectively improves the evaluation precision of the retrieval systems.

### BRIEF DESCRIPTION OF THE DRAWINGS

FIG. 1 is a schematic diagram of a running environment for an embodiment of an information retrieval precision evaluation system of the present invention;

FIG. 2 is a flowchart of an embodiment of the present invention;

FIG. 3 shows steps of a precision analysis rule in Step S3 shown in FIG. 1;

FIG. 4 is a schematic diagram of functional modules according to an embodiment of the present invention;

FIG. 5 is a structure diagram of a sequence number generation module shown in FIG. 4; and

FIG. 6 is a structure diagram of a precision judgment module shown in FIG. 4.

### DETAILED DESCRIPTION OF THE EMBODIMENTS

Principles and characteristics of the present invention will be described below in combination with the accompanying drawings. Examples are listed only to explain the present invention and not intended to limit the scope of the present invention.

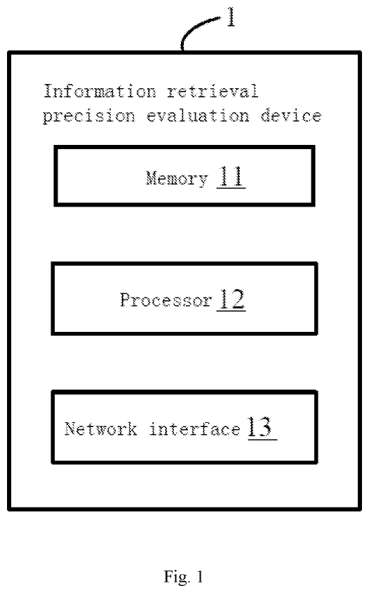

Referring to FIG. 1, a schematic diagram of a running environment for a preferred embodiment of an information retrieval precision evaluation system 10 of the present invention is shown.

In the embodiment, the information retrieval precision evaluation system 10 is installed and run in an information retrieval precision evaluation device 1.

The information retrieval precision evaluation device 1 is equipment capable of automatically performing numerical value calculation and/or information processing according to an instruction set or stored in advance. The information retrieval precision evaluation device 1 may be a computer, and may also be a single network server, a server group formed by multiple network servers or a cloud-computing-based cloud formed by a large number of host computers or network servers, wherein cloud computing is a kind of distributed computing, and is executed by a virtual supercomputer formed by a loosely coupled computer set.

In the embodiment, the information retrieval precision evaluation device 1 includes, but not limited to, a memory 11, a processor 12 and a network interface 13, which form mutual communication connections through a system bus. It is necessary to point out that only the information retrieval precision evaluation device 1 with the components 11-13 is shown in FIG. 1. However, it should be understood that not all of the shown components are required to be implemented and more or fewer components may be implemented instead.

Wherein, the memory 11 includes an internal memory and at least one type of readable storage medium. The internal memory provides a cache for running of the information retrieval precision evaluation device 1; and the readable storage medium may be a nonvolatile storage medium such as a flash memory, a hard disk, a multimedia card and a card type memory. In some embodiments, the storage medium may be an internal storage unit of the information retrieval precision evaluation device 1, for example, a hard disk of the information retrieval precision evaluation device 1; and in some other embodiments, the nonvolatile storage medium may also be external storage equipment of the information retrieval precision evaluation device 1, for example, a plug-in type hard disk, Smart Media Card (SMC), Secure Digital (SD) card and flash card configured on the information retrieval precision evaluation device 1. In the embodiment, the readable storage medium of the memory 11 is usually configured to store an operating system and various types of application software installed in the information retrieval precision evaluation device 1, for example, a program code of the information retrieval precision evaluation system 10 in an embodiment of the present application. In addition, the memory 11 may further be configured to temporally store various types of data which have been output or will be output.

The processor 12, in some embodiments, may be a Central Processing Unit (CPU), a microprocessor or another data processing chip. The processor 12 is usually configured to control overall operation of the information retrieval precision evaluation device 1, and for example, in the embodiment, is configured to run the program code stored in the memory 11 or process data, for example, executing the information retrieval precision evaluation system 10.

The network interface 13 may include a wireless network interface or a wired network interface, and the network interface 13 is usually configured to establish a communication connection between the information retrieval precision evaluation device 1 and other electronic equipment.

It is necessary to note that, in some embodiments, the information retrieval precision evaluation device 1 further includes a display (the display is not shown in the figure). In some embodiments, the display may be a Light-Emitting Diode (LED) display, a liquid crystal display, a touch liquid crystal display, an Organic Light-Emitting Diode (OLED) touch display and the like. For example, in some other embodiments of the present invention, the display is configured to display information processed in the information retrieval precision evaluation device 1 and configured to display a visual user interface, for example, an information retrieval result display interface.

The information retrieval precision evaluation system 10 includes at least one computer-readable instruction stored in the memory 11, and the at least one computer-readable instruction may be executed by the processor 12 to implement an information retrieval precision evaluation method in each embodiment of the present application. As described hereinafter, the at least one computer-readable instruction may be divided into different logic modules according to different functions realized by each part.

In an embodiment, the information retrieval precision evaluation system 10 is executed by the processor 12 to implement the following operation: at first, at least one first retrieval result corresponding to a predetermined keyword is retrieved by virtue of a first predetermined retrieval system, and at least one second retrieval result corresponding to the keyword is retrieved by virtue of a second predetermined retrieval system; then, a first retrieval sequence number corresponding to the first retrieval result and a second retrieval sequence number corresponding to the second retrieval result are generated according to a preset sequence number generation rule; and finally, the generated first retrieval sequence number and second retrieval sequence number are analyzed according to a predetermined precision analysis rule to obtain precision of the first retrieval system relative to the second retrieval system.

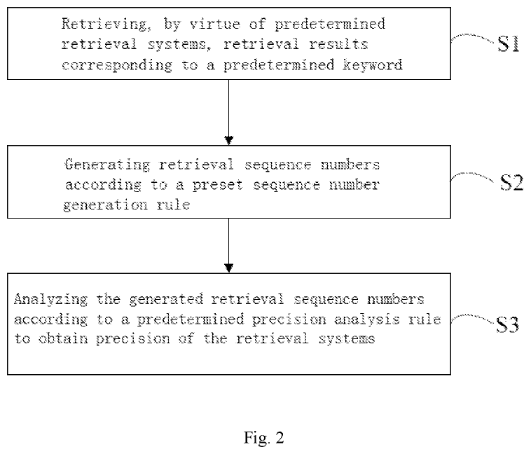

As shown in FIG. 2, FIG. 2 is a flowchart of an embodiment of the present invention. From FIG. 2, it can be seen that an information retrieval precision evaluation method of the embodiment includes the following steps.

In Step S1, retrieval results corresponding to a predetermined keyword are retrieved by virtue of predetermined retrieval systems.

Preferably, in the embodiment, the predetermined retrieval systems include a first retrieval system and a second retrieval system, wherein the first retrieval system and the second retrieval system may be uncorrelated retrieval systems, or the second retrieval system is an optimized and upgraded system of the first retrieval system.

Furthermore, the first retrieval system retrieves a first retrieval result corresponding to the predetermined keyword, and a second retrieval result corresponding to a keyword the same as the predetermined keyword for retrieval of the first retrieval system is retrieved by virtue of the second retrieval system. It can be understood that the first retrieval result includes multiple retrieval results with different contents, and the second retrieval result also includes multiple retrieval results with different contents. The numbers of the first retrieval result and the second retrieval result may be the same and may also be different.

In Step S2, retrieval sequence numbers are generated according to a preset sequence number generation rule. It can be understood in combination with Step S1 that, in the embodiment, a first retrieval sequence number corresponding to the first retrieval result and a second retrieval sequence number corresponding to the second retrieval result are generated according to the preset sequence number generation rule.

Preferably, in the embodiment, the step includes that:

a third retrieval result matched with the predetermined keyword is screened from the first retrieval result according to a predetermined screening rule, and a fourth retrieval result matched with the predetermined keyword is screened from the second retrieval result;

a first rank number of each retrieval content in the third retrieval result in the first retrieval result is determined, and a second rank number of each retrieval content in the fourth retrieval result in the second retrieval result is determined; and

the first retrieval sequence number corresponding to the first retrieval result is generated according to the first rank number, and the second retrieval sequence number corresponding to the second retrieval result is generated according to the second rank number.

Wherein, the retrieval contents include a name and link address content of a related webpage matched with the retrieval keyword, a name and link address content of a related document matched with the retrieval keyword and the like.

Furthermore, the predetermined screening rule includes: manually screening retrieval results matched with the predetermined keyword from the first retrieval result and the second retrieval result; or determining an associated word corresponding to the predetermined keyword according to a predetermined mapping relationship between a keyword and an associated word, making statistics on the total number of the predetermined keyword and corresponding associated word thereof in each retrieval result, if the total number corresponding to a retrieval result is larger than or equal to a preset number, determining that the retrieval result is a retrieval result matched with the predetermined keyword, and if the total number corresponding to a retrieval result is smaller than the preset number, determining that the retrieval result is a retrieval result mismatched with the predetermined keyword.

In Step S3, the generated retrieval sequence numbers are analyzed according to a predetermined precision analysis rule to obtain precision of the retrieval systems.

Corresponding to Step S1 and Step S2, it can be understood that, in the embodiment, the generated first retrieval sequence number and second retrieval sequence number are analyzed according to the predetermined precision analysis rule to obtain precision of the first retrieval system and the second retrieval system.

Compared with the prior art, the embodiment has the following advantages: the retrieval results of each retrieval system corresponding to the predetermined keyword are retrieved by virtue of different retrieval systems, then the retrieval results matched with the retrieval keyword are screened from each retrieval result, the retrieval results matched with the retrieval keyword are ranked according to the contents of the retrieval results to obtain different rank numbers corresponding to different retrieval systems, and each different rank number is analyzed and calculated according to a predetermined formula to obtain the precision corresponding to different retrieval systems, so that a lot of manual operation is effectively avoided, and meanwhile, retrieval precision evaluation of the information retrieval systems is effectively improved.

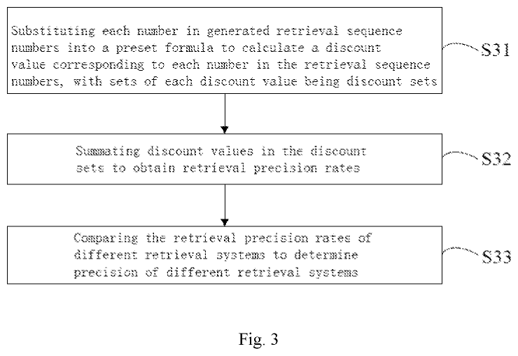

Preferably, FIG. 3 shows steps of the precision analysis rule in Step S3 shown in FIG. 2. From FIG. 3, it can be seen that, in the embodiment, the precision analysis rule includes the following steps.

In S31, each number in the generated retrieval sequence numbers is substituted into a preset formula to calculate a discount value corresponding to each number in the retrieval sequence numbers, with sets of each discount value being discount sets.

From each step of FIG. 2, it can be seen that, in the embodiment, the step includes that: each number in the generated first retrieval sequence number is substituted into the preset formula to calculate a first discount value corresponding to each number in the first retrieval sequence number, wherein a set of each calculated first discount value is a first discount set corresponding to the first retrieval system; and

each number in the generated second retrieval sequence number is substituted into the preset formula to calculate a second discount value corresponding to each number in the second retrieval sequence number, wherein a set of each calculated second discount value is a second discount set corresponding to the second retrieval system. Furthermore, the preset formula is 1/Log(1+N), where N represents a number in a retrieval sequence number.

In S32, the discount values in the discount sets are summated to obtain retrieval precision rates. It can be understood that, in the embodiment, the step includes that each discount value in the first discount set is summated to obtain a first precision rate corresponding to the first retrieval system and each discount value in the second discount set is summated to obtain a second precision rate corresponding to the second retrieval system.

In S33, the retrieval precision rates of different retrieval systems are compared to determine the precision of different retrieval systems. In the embodiment, the step includes that the first precision rate and the second precision rate are analyzed to determine the precision of the first retrieval system relative to the second retrieval system. Specifically, a magnitude relationship between the first precision rate and the second precision rate is compared to determine the precision of the first retrieval system and the second retrieval system.

Preferably, the operation that the precision of the first retrieval system and the second retrieval system is determined includes that: the magnitude relationship between the first precision rate and the second precision rate is analyzed, and if the first precision rate is higher than the second precision rate, it is determined that the retrieval result of the first retrieval system is more precise than the retrieval result of the second retrieval system; if the first precision rate is lower than the second precision rate, it is determined that the retrieval result of the second retrieval system is more precise than the retrieval result of the first retrieval system; and if the first precision rate is equal to the second precision rate, it is determined that precision rates of the retrieval result of the first retrieval system and the retrieval result of the second retrieval system are the same.

For example, in an embodiment, retrieval is performed once in the first retrieval system and second retrieval system which are different by using the same keyword respectively. In the first retrieval system, first 10 retrieval results returned by the first retrieval system are sequentially selected, 5 matched retrieval results are obtained according to a preset judgment standard, first sequence numbers 1, 2, 4, 5 and 9 are obtained, and then discount analysis is performed according to the preset formula 1/Log(1+N) to obtain first discount sets 1/Log(1+1), 1/Log(1+2), 1/Log(1+4), 1/Log(1+5) and 1/Log(1+9). In the second retrieval system, first 10 retrieval results returned by the second retrieval system are sequentially selected, 6 matched retrieval results are obtained according to the preset judgment standard, second sequence numbers 1, 6, 7, 8, 9 and 10 are obtained, and then discount analysis is performed according to the preset formula 1/Log(1+N) to obtain second discount sets 1/Log(1+1), 1/Log(1+6), 1/Log(1+7), 1/Log(1+8), 1/Log(1+9) and 1/Log(1+10).

Furthermore, each discount value in the first discount sets is summated to obtain the first precision rate L1 corresponding to the first retrieval system. Each discount value in the second discount sets is summated to obtain the second precision rate L2 corresponding to the second retrieval system, wherein

L1=(1/Log(1+1))+(1/Log(1+2))+(1/Log(1+4))+(1/Log(1+5))+(1/Log(1+9)), and

L2=(1/Log(1+1))+(1/Log(1+6))+(1/Log(1+7))+(1/Log(1+8))+(1/Log(1+9))+(1/Log(1+10)).

Magnitudes of values of L1 and L2 are compared, it can be seen that the value of L1 is larger than the value of L2, and then it is determined that the retrieval results of the first retrieval system are more precise than the retrieval results of the second retrieval system.

It can be understood that, if the second retrieval system is an optimized and updated retrieval system of the first retrieval system, it may be determined that the first retrieval system fails to be optimized. In the embodiment, although the number (6) of the retrieval results retrieved by the second retrieval system and matched with the preset retrieval keyword is larger than the number (5) of the retrieval results retrieved by the first retrieval system and matched with the preset retrieval keyword, ranks of the retrieval results retrieved by the first retrieval system and matched with the preset retrieval keyword in the returned retrieval results are overall higher than ranks of the matched retrieval results retrieved by the second retrieval system in the returned retrieval results, so that it is determined that the retrieval results of the first retrieval system are more precise than the retrieval results of the second retrieval system, and a precise precision analysis result of the information retrieval results is provided under the condition of a small calculated amount.

Compared with the prior art, the embodiment has the following advantages: the retrieval results of each retrieval system corresponding to the predetermined keyword are retrieved by virtue of different retrieval systems, then the retrieval results matched with the retrieval keyword are screened from each retrieval result, the retrieval results matched with the retrieval keyword are ranked according to the contents of the retrieval results to obtain different rank numbers corresponding to different retrieval systems, and each different rank number is analyzed and calculated according to the predetermined formula to obtain the precision corresponding to different retrieval systems, so that a lot of manual operation is effectively avoided, and meanwhile, retrieval precision evaluation of the information retrieval systems is effectively improved.

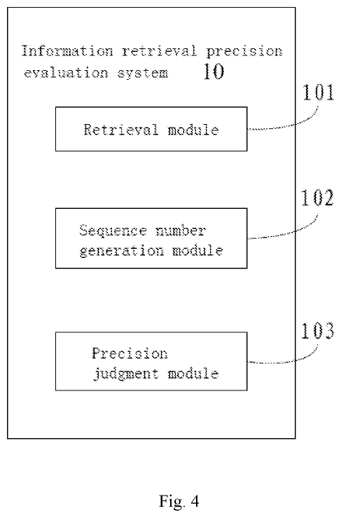

Referring to FIG. 4, a schematic diagram of functional modules of a preferred embodiment of an information retrieval precision evaluation system 10 of the present invention is shown. In the embodiment, the information retrieval precision evaluation system 10 may be divided into one or more modules, and the one or more modules are stored in a memory 11 and executed by one or more processors (a processor 12 in the embodiment) to implement the present invention. For example, in FIG. 4, the information retrieval precision evaluation system 10 may be divided into a retrieval module 101, a sequence number generation module 102 and a precision judgment module 103. The modules mentioned in the present invention refer to a series of computer program instruction segments capable of realizing specific functions and are more suitable for describing an execution process of the information retrieval precision evaluation system 10 in an electronic device 1 in comparison to programs, wherein

the retrieval module 101 is configured to retrieve, by virtue of a first predetermined retrieval system, at least one first retrieval result corresponding to a predetermined keyword and retrieve, by virtue of a second predetermined retrieval system, at least one second retrieval result corresponding to the keyword;

the sequence number generation module 102 is configured to generate a first retrieval sequence number corresponding to the first retrieval result and a second retrieval sequence number corresponding to the second retrieval result according to a preset sequence number generation rule; and

the precision judgment module 103 is configured to analyze the generated first retrieval sequence number and second retrieval sequence number according to a predetermined precision analysis rule to obtain the precision of the first retrieval system and the second retrieval system.

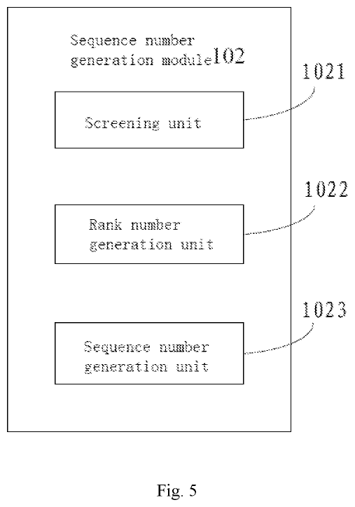

Furthermore, as shown in FIG. 5, in the embodiment, the sequence number generation module 102 is divided into a screening unit 1021, a rank number generation unit 1022 and a sequence number generation unit 1023,

wherein the screening unit 1021 is configured to screen a third retrieval result matched with the predetermined keyword from the first retrieval result according to a predetermined screening rule and screen a fourth retrieval result matched with the predetermined keyword from the second retrieval result;

the rank number generation unit 1022 is configured to determine a first rank number of each retrieval content in the third retrieval result in the first retrieval result and determine a second rank number of each retrieval content in the fourth retrieval result in the second retrieval result; and

the sequence number generation unit 1023 is configured to generate the first retrieval sequence number corresponding to the first retrieval result according to the first rank number and generate the second retrieval sequence number corresponding to the second retrieval result according to the second rank number.

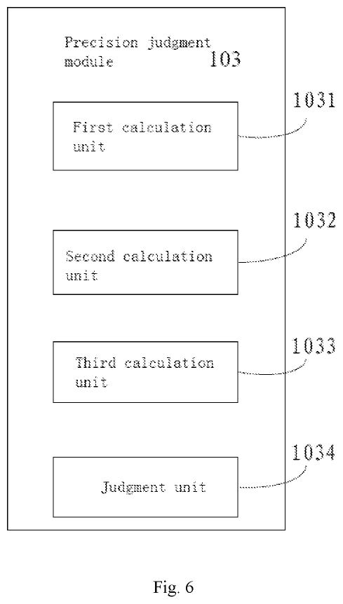

Furthermore, as shown in FIG. 6, in the embodiment, the precision judgment module 102 is divided into a first calculation unit 1031, a second calculation unit 1032, a third calculation unit 1033 and a judgment unit 1034,

wherein the first calculation unit 1031 is configured to substitute each number in the generated first retrieval sequence number into a preset formula to calculate a first discount value corresponding to each number in the first retrieval sequence number, a set of each calculated first discount value being a first discount set corresponding to the first retrieval system;

the second calculation unit 1032 is configured to substitute each number in the generated second retrieval sequence number into the preset formula to calculate a second discount value corresponding to each number in the second retrieval sequence number, a set of each calculated second discount value being a second discount set corresponding to the second retrieval system;

the third calculation unit 1033 is configured to summate each discount value in the first discount set to obtain a first precision rate corresponding to the first retrieval system and summate each discount value in the second discount set to obtain a second precision rate corresponding to the second retrieval system; and

the judgment unit 1034 is configured to analyze the first precision rate and the second precision rate to determine precision of the first retrieval system and the second retrieval system.

Furthermore, the judgment unit 1034 includes an analysis subunit (not shown in the figure), and the analysis subunit is configured to analyze a magnitude relationship between the first precision rate and the second precision rate,

if the first precision rate is higher than the second precision rate, determine that the retrieval result of the first retrieval system is more precise than the retrieval result of the second retrieval system,

if the first precision rate is lower than the second precision rate, determine that the retrieval result of the second retrieval system is more precise than the retrieval result of the first retrieval system, and

if the first precision rate is equal to the second precision rate, determine that precision rates of the retrieval result of the first retrieval system and the retrieval result of the second retrieval system are the same.

Compared with the prior art, the embodiment has the following advantages: the retrieval results of each retrieval system corresponding to the predetermined keyword are retrieved by virtue of different retrieval systems, then the retrieval results matched with the retrieval keyword are screened from each retrieval result, the retrieval results matched with the retrieval keyword are ranked according to the contents of the retrieval results to obtain different rank numbers corresponding to different retrieval systems, and each different rank number is analyzed and calculated according to the predetermined formula to obtain the precision corresponding to different retrieval systems, so that a lot of manual operation is effectively avoided, and meanwhile, retrieval precision evaluation of the information retrieval system is effectively improved.

From each foregoing embodiment, it can be seen that, compared with a present relatively universal and popular precision detection method, the information retrieval precision evaluation method and system of the present invention have the advantages that a large-scale manual data marking step is eliminated, and the precision of the retrieval results of the retrieval systems is further improved under the condition of reducing the labor workload.

The above is only the preferred embodiment of the present invention and not intended to limit the present invention. Any modifications, equivalent replacements, improvements and the like made within the spirit and principle of the present invention shall fall within the scope of protection of the present invention.

1. An information retrieval precision evaluation method, the method comprising the following steps:
step A: retrieving, by a first predetermined retrieval system, at least one first retrieval result corresponding to a predetermined keyword, and retrieving, by a second predetermined retrieval system, at least one second retrieval result corresponding to the predetermined keyword;
step B: generating a first retrieval sequence number corresponding to the first retrieval result and a second retrieval sequence number corresponding to the second retrieval result according to a preset sequence number generation rule; and
step C: analyzing the first retrieval sequence number and the second retrieval sequence number according to a predetermined precision analysis rule to obtain a precision of the first retrieval system relative to the second retrieval system.

2. The information retrieval precision evaluation method of claim 1, wherein step B comprises the following steps:
step E: screening a third retrieval result matched with the predetermined keyword from the first retrieval result according to a predetermined screening rule, and screening a fourth retrieval result matched with the predetermined keyword from the second retrieval result;
step F: determining a first rank number of each retrieval content in the third retrieval result, and determining a second rank number of each retrieval content in the fourth retrieval result; and
step G: generating the first retrieval sequence number corresponding to the first retrieval result according to the first rank number, and generating the second retrieval sequence number corresponding to the second retrieval result according to the second rank number.

3. The information retrieval precision evaluation method of claim 2, wherein the predetermined screening rule comprises:
manually screening retrieval results matched with the predetermined keyword from the first retrieval result and the second retrieval result; or
determining an associated word corresponding to the predetermined keyword according to a predetermined mapping relationship between the predetermined keyword and an associated word, making statistics on a total number of the predetermined keyword and the associated word in the retrieval result, if the total number corresponding to the retrieval result is larger than or equal to a preset number, determining that the retrieval result is matched with the predetermined keyword, and if the total number corresponding to the retrieval result is smaller than the preset number, determining that the retrieval result is mismatched with the predetermined keyword.

4. The information retrieval precision evaluation method of claim 1, wherein the predetermined precision analysis rule comprises:
step H: substituting a number in the first retrieval sequence number into a preset formula to calculate a first discount value corresponding to the number in the first retrieval sequence number, wherein a set of the first discount values is a first discount set corresponding to the first retrieval system;
step I: substituting a number in the generated second retrieval sequence number into the preset formula to calculate a second discount value corresponding to the number in the second retrieval sequence number, wherein a set of the second discount values is a second discount set corresponding to the second retrieval system;
step J: summating the first discount values in the first discount set to obtain a first precision rate corresponding to the first retrieval system, and summating the second discount values in the second discount set to obtain a second precision rate corresponding to the second retrieval system; and
step K: analyzing the first precision rate and the second precision rate to determine the precision of the first retrieval system relative to the second retrieval system.

5. The information retrieval precision evaluation method of claim 4, wherein the step K comprises:
analyzing a magnitude relationship between the first precision rate and the second precision rate;
if the first precision rate is higher than the second precision rate, determining that the first retrieval result of the first retrieval system is more precise than the second retrieval result of the second retrieval system;
if the first precision rate is lower than the second precision rate, determining that the first retrieval result of the second retrieval system is more precise than the second retrieval result of the first retrieval system; and
if the first precision rate is equal to the second precision rate, determining that precision rates of the first retrieval result of the first retrieval system and the second retrieval result of the second retrieval system are the same.

6. (canceled)

7. (canceled)

8. (canceled)

9. (canceled)

10. (canceled)

11. An information retrieval precision evaluation device, comprising: a memory, a processor and an information retrieval precision evaluation system stored on the memory and capable of running on the processor, wherein the information retrieval prevision evaluation system is executed by the processor to execute the following steps:
step A: retrieving, by a first predetermined retrieval system, at least one first retrieval result corresponding to a predetermined keyword, and retrieving, by a second predetermined retrieval system, at least one second retrieval result corresponding to the predetermined keyword;
step B: generating a first retrieval sequence number corresponding to the first retrieval result and a second retrieval sequence number corresponding to the second retrieval result according to a preset sequence number generation rule; and
step C: analyzing the first retrieval sequence number and the second retrieval sequence number according to a predetermined precision analysis rule to obtain a precision of the first retrieval system relative to the second retrieval system.

12. The information retrieval precision evaluation device of claim 11, wherein Step B executed by the processor comprises the steps of:
step E: screening a third retrieval result matched with the predetermined keyword from the first retrieval result according to a predetermined screening rule, and screening a fourth retrieval result matched with the predetermined keyword from the second retrieval result;
step F: determining a first rank number of each retrieval content in the third retrieval result, and determining a second rank number of each retrieval content in the fourth retrieval result; and
step G: generating the first retrieval sequence number corresponding to the first retrieval result according to the first rank number, and generating the second retrieval sequence number corresponding to the second retrieval result according to the second rank number.

13. The information retrieval precision evaluation device of claim 12, wherein the predetermined screening rule comprises:
determining an associated word corresponding to the predetermined keyword according to a predetermined mapping relationship between the predetermined keyword and an associated word, making statistics on a total number of the predetermined keyword and the associated word in the retrieval result, if the total number corresponding to the retrieval result is larger than or equal to a preset number, determining that the retrieval result is matched with the predetermined keyword, and if the total number corresponding to the retrieval result is smaller than the preset number, determining that the retrieval result is mismatched with the predetermined keyword.

14. The information retrieval precision evaluation device of claim 11, wherein the predetermined precision analysis rule comprises:
step H: substituting a number in the first retrieval sequence number into a preset formula to calculate a first discount value corresponding to the number in the first retrieval sequence number, wherein a set of the first discount values is a first discount set corresponding to the first retrieval system;
step I: substituting a number in the generated second retrieval sequence number into the preset formula to calculate a second discount value corresponding to the number in the second retrieval sequence number, wherein a set of the second discount values is a second discount set corresponding to the second retrieval system;
step J: summating the first discount values in the first discount set to obtain a first precision rate corresponding to the first retrieval system, and summating the second discount values in the second discount set to obtain a second precision rate corresponding to the second retrieval system; and
step K: analyzing the first precision rate and the second precision rate to determine the precision of the first retrieval system relative to the second retrieval system.

15. The information retrieval precision evaluation device of claim 14, wherein the step K, executed by the processor, comprises:
analyzing a magnitude relationship between the first precision rate and the second precision rate;
if the first precision rate is higher than the second precision rate, determining that the first retrieval result of the first retrieval system is more precise than the second retrieval result of the second retrieval system;
if the first precision rate is lower than the second precision rate, determining that the first retrieval result of the second retrieval system is more precise than the second retrieval result of the first retrieval system; and
if the first precision rate is equal to the second precision rate, determining that precision rates of the first retrieval result of the first retrieval system and the second retrieval result of the second retrieval system are the same.

16. A computer-readable storage medium storing therein at least one computer-readable instruction executable for processing equipment to implement the following operation:
step A: retrieving, by a first predetermined retrieval system, at least one first retrieval result corresponding to a predetermined keyword, and retrieving, by a second predetermined retrieval system, at least one second retrieval result corresponding to the predetermined keyword;
step B: generating a first retrieval sequence number corresponding to the first retrieval result and a second retrieval sequence number corresponding to the second retrieval result according to a preset sequence number generation rule; and
step C: analyzing the first retrieval sequence number and the second retrieval sequence number according to a predetermined precision analysis rule to obtain a precision of the first retrieval system relative to the second retrieval system.

17. The medium of claim 16, wherein Step B executed by the at least one computer instruction comprises the following steps:
step E: screening a third retrieval result matched with the predetermined keyword from the first retrieval result according to a predetermined screening rule, and screening a fourth retrieval result matched with the predetermined keyword from the second retrieval result;
step F: determining a first rank number of each retrieval content in the third retrieval result, and determining a second rank number of each retrieval content in the fourth retrieval result; and
step G: generating the first retrieval sequence number corresponding to the first retrieval result according to the first rank number, and generating the second retrieval sequence number corresponding to the second retrieval result according to the second rank number.

18. The medium of claim 17, wherein the predetermined screening rule comprises:
manually screening retrieval results matched with the predetermined keyword from the first retrieval result and the second retrieval result; or
determining an associated word corresponding to the predetermined keyword according to a predetermined mapping relationship between the predetermined keyword and an associated word, making statistics on a total number of the predetermined keyword and the associated word in the retrieval result, if the total number corresponding to the retrieval result is larger than or equal to a preset number, determining that the retrieval result is matched with the predetermined keyword, and if the total number corresponding to the retrieval result is smaller than the preset number, determining that the retrieval result is mismatched with the predetermined keyword.

19. The medium of claim 16, wherein the predetermined precision analysis rule comprises:
step H: substituting a number in the first retrieval sequence number into a preset formula to calculate a first discount value corresponding to the number in the first retrieval sequence number, wherein a set of the first discount values is a first discount set corresponding to the first retrieval system;
step I: substituting a number in the generated second retrieval sequence number into the preset formula to calculate a second discount value corresponding to the number in the second retrieval sequence number, wherein a set of the second discount values is a second discount set corresponding to the second retrieval system;
step J: summating the first discount values in the first discount set to obtain a first precision rate corresponding to the first retrieval system, and summating the second discount values in the second discount set to obtain a second precision rate corresponding to the second retrieval system; and
step K: analyzing the first precision rate and the second precision rate to determine the precision of the first retrieval system relative to the second retrieval system.

20. The medium of claim 19, wherein the step K, executed by the at least one computer instruction, comprises:
analyzing a magnitude relationship between the first precision rate and the second precision rate;
if the first precision rate is higher than the second precision rate, determining that the first retrieval result of the first retrieval system is more precise than the second retrieval result of the second retrieval system;
if the first precision rate is lower than the second precision rate, determining that the first retrieval result of the second retrieval system is more precise than the second retrieval result of the first retrieval system; and
if the first precision rate is equal to the second precision rate, determining that precision rates of the first retrieval result of the first retrieval system and the second retrieval result of the second retrieval system are the same.
